(19) United States
(12) Patent Application Publication
(10) Pub. No.: US 2012/0113453 A1
(43) Pub. Date: May 10, 2012

(54) INFORMATION PROCESSING APPARATUS, INFORMATION PROCESSING APPARATUS CONTROL METHOD, AND PROGRAM

(75) Inventor: Fumitoshi Ito, Kawasaki-shi (JP)

(73) Assignee: CANON KABUSHIKI KAISHA, Tokyo (JP)

(21) Appl. No.: 13/265,637

(22) PCT Filed: May 31, 2011
(86) PCT No.: PCT/JP2011/062875

§ 371 Date: Oct. 21, 2011

(30) Foreign Application Priority Data
Jun. 7, 2010 (JP) 2010-130448
May 19, 2011 (JP) 2011-112898

(51) Int. Cl. G06F 3/12

(52) U.S. Cl. 358/1.13

(57) ABSTRACT

There is provided a technique for enabling, as needed, a Web service for controlling execution of each function of an MFP when executing the function in response to a request from a Web server in an information processing apparatus. An information processing apparatus of the present invention includes a Web browser which transmits input information input through an displayed operation screen based on screen information provided from a Web server. Upon receiving, from the Web server, an execution request of processing corresponding to the input information, the information processing apparatus registers in a Web service server a service (Web service) defined in definition information contained in the execution request when starting execution of the processing according to the execution request. The web service server provides, among a plurality of providable services, the registered service which is used for controlling the execution of the processing.

### TECHNICAL FIELD

The present invention relates to an information processing apparatus which can connect to a Web server and displays an operation screen based on screen information provided by the Web server, an information processing apparatus control method, and a program.

### BACKGROUND ART

It is known to connect an information processing apparatus such as a PC to a Web server on a network, and to display, by the Web browser of the information processing apparatus, an operation screen provided by the Web server. In this case, the Web browser of the information processing apparatus first requests, of the Web server, screen information about an operation screen. Upon receiving the request from the information processing apparatus, a Web application in the Web server responds to the request by sending back, to the information processing apparatus, an HTML file corresponding to the screen information for causing the Web browser to display an operation screen. The Web browser of the information processing apparatus parses the received HTML file, and displays the operation screen based on the description of the HTML file on a display unit such as a display.

If the user inputs an instruction via the operation screen displayed by the Web browser in the information processing apparatus, the Web browser notifies the Web server of the input instruction. Upon receiving the notification, the Web application in the Web server executes processing according to the received instruction.

Some recent Multi Function Peripherals (MFPs) having a scanner and a printer include the above-mentioned Web browser. The MFP displays an operation screen based on screen information provided by the Web server using the above procedures on the display unit through the Web browser, and accepts various instructions input through the displayed operation screen by the user.

According to Japanese Patent Laid-Open No. 2006-127503, for example, the Web server provides an MFP with screen information about an operation screen for inputting an instruction to use each function of the MFP. The user of the MFP inputs an instruction to the MFP using the displayed operation screen. The Web browser of the MFP notifies the Web server of the input instruction as a request. Upon receiving the notification, the Web server generates a script describing various processes for the MFP based on the input instruction. The Web server notifies the MFP of the generated script as a response to the above-mentioned request from the Web browser. The MFP passes, from the Web browser to a script processing unit, the script sent from the Web server to execute the script, thereby using a function of the device of the MFP.

According to Japanese Patent Laid-Open No. 2008-003833, unlike Japanese Patent Laid-Open No. 2006-127503, the Web browser of an MFP executes a screen display script. The MFP calls a Web service for processing a function of the MFP within the script to use a function of the device of the MFP.

In the MFP described in Japanese Patent Laid-Open No. 2006-127503, software of the script processing unit displays, during execution of the script, an operation screen for inputting an instruction associated with the execution process. The MFP, therefore, cannot display a screen provided by the Web application of the Web server during execution of the script. Furthermore, it is difficult to customize the operation screen.

In the MFP described in Japanese Patent Laid-Open No. 2008-003833, in order for the Web application of the Web server to control the user interface (UI) of the MFP, the MFP must always enable the Web server to use a Web service for causing the Web server to control a function of the MFP regardless of whether the script is in progress. Therefore, MFP resources such as a memory are needed even when the script is not in progress.

### SUMMARY OF INVENTION

The present invention has been made in consideration of the above problems, and provides a technique which allows, as needed, to use a service for controlling execution of a function of an MFP when executing the function in the MFP in response to a request from a Web server.

According to one aspect of the present invention, there is provided a information processing apparatus connectable to a Web server, the information processing apparatus comprising: display control means including transmission means for displaying an operation screen based on screen information provided by the Web server, and transmitting input information input through the operation screen to the Web server, and reception means for receiving, from the Web server, an execution request of processing corresponding to the input information transmitted by the transmission means, the execution request containing definition information of a service associated with execution of the processing; execution control means for executing, upon receiving the execution request from the Web server via the display control means, processing according to the execution request; and service providing means for providing, among a plurality of providable services for controlling the execution control means, a service which is registered by the execution control means, the execution control means including registration means for registering in the service providing means the service defined in the definition information contained in the execution request when starting execution of the processing according to the execution request.

According to another aspect of the present invention, there is provided a control method for controlling an information processing apparatus connectable to a Web server, the control method comprising: causing display control means of the information processing apparatus to display an operation screen based on screen information provided by the Web server, and transmit input information input through the operation screen to the Web server; causing the display control means to receive, from the Web server, an execution request of processing corresponding to the input information transmitted in the causing the display control means to display, the execution request containing definition information of a service associated with execution of the processing; causing execution control means of the information processing apparatus to execute, upon receiving the execution request from the Web server via the display control means, processing according to the execution request; and causing service providing means of the information processing apparatus to provide, among a plurality of providable services for controlling the execution control means, a service which is registered by the execution control means, the causing the execution control means to execute including registering in the service providing means the service defined in the definition information contained in the execution request when starting execution of the processing according to the execution request.

According to the present invention, it is possible to provide a technique which allows, as needed, to use a service for controlling execution of a function of an MFP when executing the function in the MFP in response to a request from a Web server.

Further features of the present invention will become apparent from the following description of exemplary embodiments (with reference to the attached drawings).

### BRIEF DESCRIPTION OF DRAWINGS

FIG. 1 is a view showing the overall configuration of an information processing system according to the first embodiment;

FIG. 2 is a block diagram showing the hardware configuration of an MFP according to the first embodiment;

FIG. 3 is a block diagram showing the hardware configuration of a Web server according to the first embodiment;

FIG. 4 is a block diagram showing the software configuration of the MFP according to the first embodiment;

FIG. 5 is a block diagram showing the software configuration of the Web server according to the first embodiment;

FIG. 6 is a chart showing a communication processing sequence according to the first embodiment;

FIG. 7 is a view showing an example of the user interface of a Web browser according to the first embodiment;

FIG. 8 is a view showing an example of a script file according to the first embodiment;

FIGS. 9A and 9B are views showing an example of HTML data according to the first embodiment;

FIG. 10 is a flowchart illustrating a script execution procedure in the MFP according to the first embodiment;

FIGS. 11A, 11B, and 11C are views each showing an example of the user interface of the Web browser in a scan execution state, standby state, or end state according to the first embodiment;

FIG. 12 is a chart showing a communication processing sequence according to the second embodiment; and

FIG. 13 is a view showing an example of HTML data according to the second embodiment.

### DESCRIPTION OF EMBODIMENTS

### First Embodiment

In the first embodiment, a case in which an MFP as an example of an information processing apparatus according to the present invention executes image forming processing in response to an instruction from a Web server will be explained.

(Overall Configuration of Information Processing System)

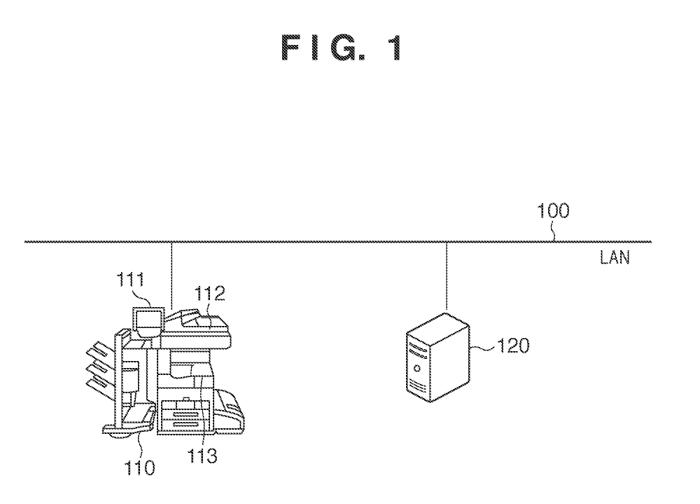

FIG. 1 is a view showing the overall configuration of an information processing system according to the first embodiment. As shown in FIG. 1, an MFP 110 and Web server 120 are connected to a LAN 100 such as Ethernet®. The MFP 110 has a copy function and a data transmission function. The data transmission function reads a document image, and transmits the acquired image data (to be also referred to as document data) to a specified device on the LAN 100 using the File Transfer Protocol (FTP), the Server Message Block (SMB) protocol, and the like. The MFP 110 may also have a function of creating an e-mail message attached with image data as an attached file, and transmitting it using an e-mail server (not shown).

The server 120 serves as a Web server. In response to a request from the MFP 110, a Web application serving as software operating on the Web server generates screen information (HTML data) for displaying an operation screen on (the liquid crystal display unit of) the operation unit of the MFP 110, and transmits it to the MFP 110 as a response to the request.

The number of components of the information processing system in this embodiment is not limited to that shown in FIG. 1. Although a LAN is applied as a connection method in this embodiment, the present invention is not limited to this. For example, any network such as a WAN (public network), a serial transmission method such as USB, and a parallel transmission method such as the Centronics and SCSI are also applicable.

(Hardware Configuration of MFP)

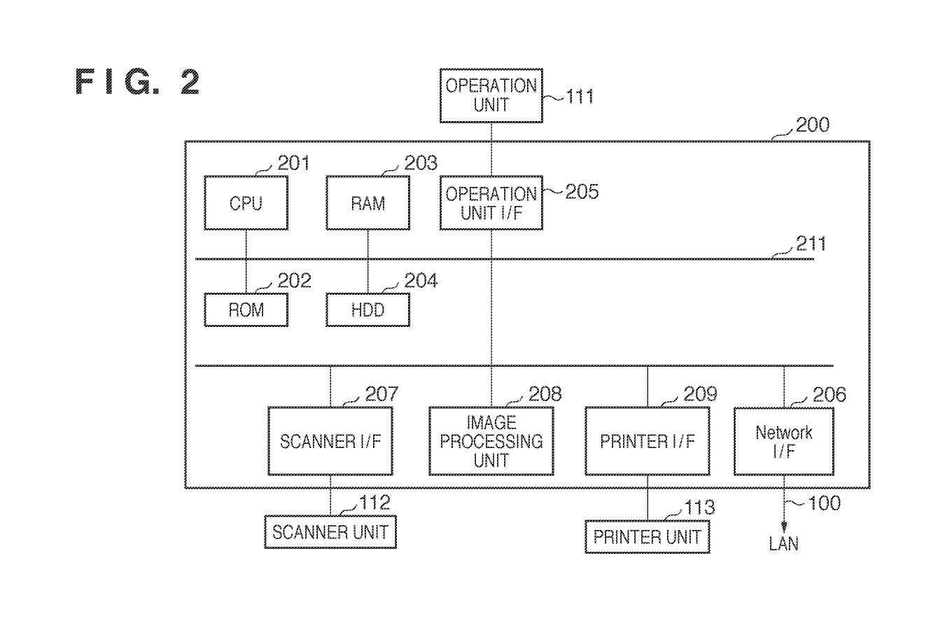

The MFP 110 includes the following components, as shown in FIG. 2. The MFP 110 has a scanner unit 112 serving as an image input device, a printer unit 113 serving as an image output device, a controller 200 for controlling the MFP 110, and an operation unit 111.

The scanner unit 112 serves as a device for reading an image on a document to generate image data. When documents are set on a document feeder and a document read instruction is given from the controller 200 to the scanner unit 112, the scanner unit 112 feeds the documents one by one from the document feeder, and reads respective documents. Note that a method of scanning a document by placing the document on a glass surface (not shown) and moving an exposure unit may be used as a document read method instead of an automatic feed method using the document feeder.

The printer unit 113 serves as an image forming device which forms an image on a paper sheet based on image data received from the controller 200. Note that in this embodiment, an electrophotographic method using a photosensitive drum or photosensitive belt, or an ink-jet method may be adopted as an image forming method used by the printer unit 113.

The controller 200 is electrically connected to the operation unit 111, scanner unit 112, and printer unit 113, while connecting to the LAN 100 via a network interface 206. That is, the controller unit 200 is also connected to other devices via the LAN 100. This enables the controller 200 to communicate with other devices (for example, the server 120) connected via the LAN 100 according to the HTTP protocol.

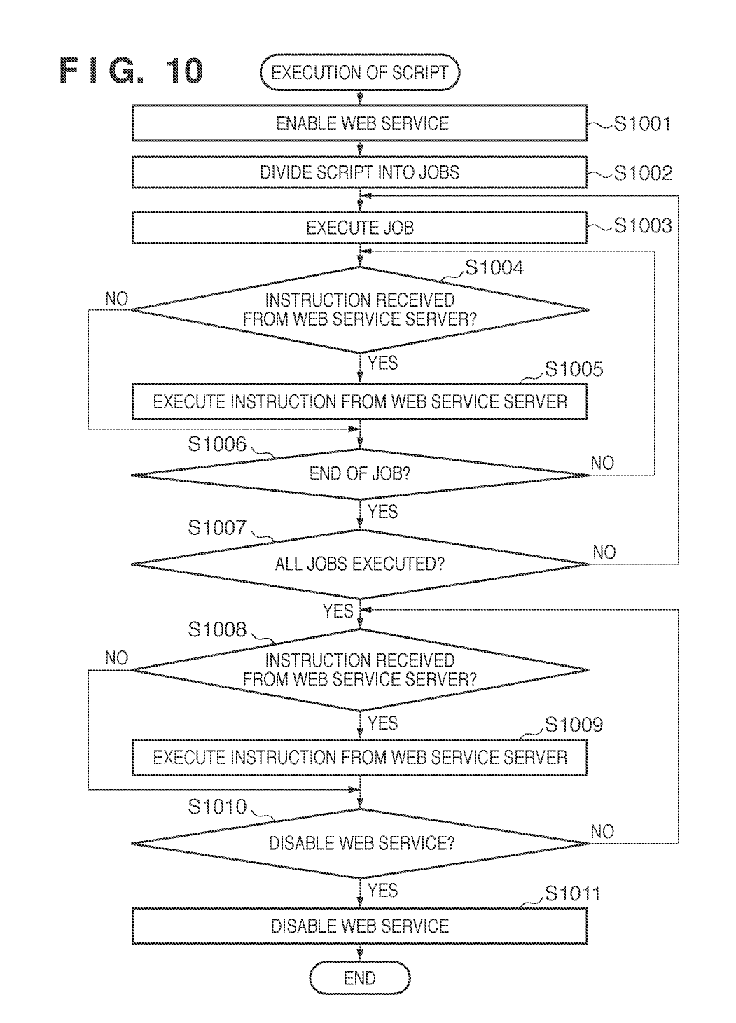

A CPU 201 centrally controls access to various devices in connection with the controller 200 and access from the devices based on a control program stored in a ROM 202. In addition, the CPU 201 centrally controls various processes executed within the controller 200. This control processing includes execution of programs for implementing processing shown in a flowchart of FIG. 10 (to be described later).

The ROM 202 stores the boot program of the apparatus in addition to the above-described control program. A RAM 203 serves as a system work memory for operation of the CPU 201, and also functions as a memory for temporarily storing image data. The RAM 203 includes an area which holds contents stored as a backup or the like even after powering off the apparatus main body, and a volatile area which erases stored contents after power off.

An HDD 204 serves as a hard disk drive, which can store system software and image data. An operation unit I/F 205 serves as an interface for connecting a system bus 211 and the operation unit 111. The operation unit I/F 205 receives image data for displaying a screen on (the liquid crystal display unit of) the operation unit 111 from the system bus 211, and outputs it to the operation unit 111. The operation unit I/F 205 also outputs, to the system bus 211, information input through the operation unit 111.

The network I/F 206 is connected to the LAN 100 and the system bus 211 to input/output information. A scanner I/F 207 corrects, processes, and edits image data received from the scanner unit 112. The scanner I/F 207 has a function of determining the type of received image data, that is, a color document or monochrome document, or a text document or photographic document.

An image processing unit 208, for example, changes the orientation of image data and compresses/decompresses an image. The image processing unit 208 can also composite a plurality of images saved in the HDD 204 to generate image data corresponding to one image. A printer I/F 209 receives image data sent from the image processing unit 208, and performs image processing on the image data with reference to attribute data added to the image data. The printer I/F 209 then outputs the image data which has undergone the image processing to the printer unit 113.

Note that in this embodiment, the MFP is a network MFP which displays a user interface (UI). The MFP, however, may be an image processing apparatus such as a general-purpose computer connected with a general-purpose scanner, a general-purpose printer, and the like.

(Hardware Configuration of Web Server)

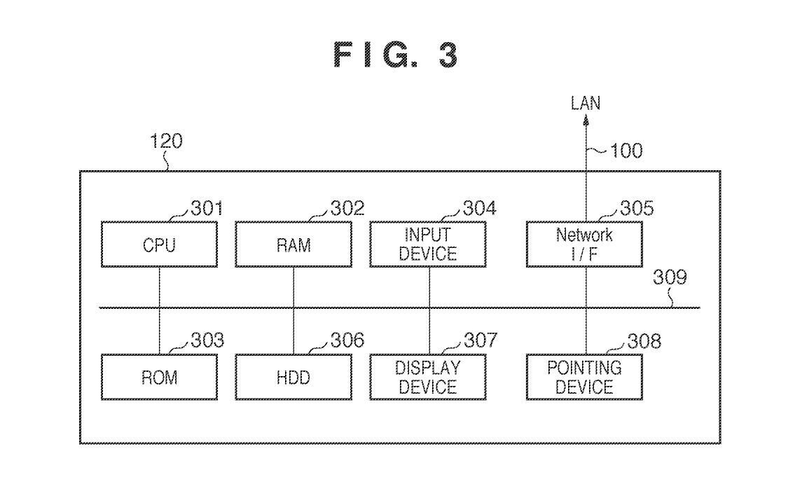

FIG. 3 is a block diagram showing the hardware configuration of the Web server 120 shown in FIG. 1. As shown in FIG. 3, a CPU 301, RAM 302, ROM 303, network I/F 305, and hard disk drive (HDD) 306 are communicably connected with each other via a system bus 309. A display device 307 such as CRT, an input device 304 such as a keyboard, and a pointing device 308 such as a mouse are also communicably connected with each other via the system bus 309.

The ROM 303 or HDD 306 stores a control program such as an operating system or Web application. The CPU 301 reads out the control program from the ROM 303 or HDD 306 into the RAM 302, and then executes it, thereby causing the computer to function as the Web server 120.

The CPU 301 displays various pieces of information using the display device 307, and also accepts a user instruction or the like from the input device 304 or pointing device 308. The CPU 301 communicates with other devices (for example, the MFP 110) on the LAN 100 via the network I/F 305.

(Software Configuration of MFP)

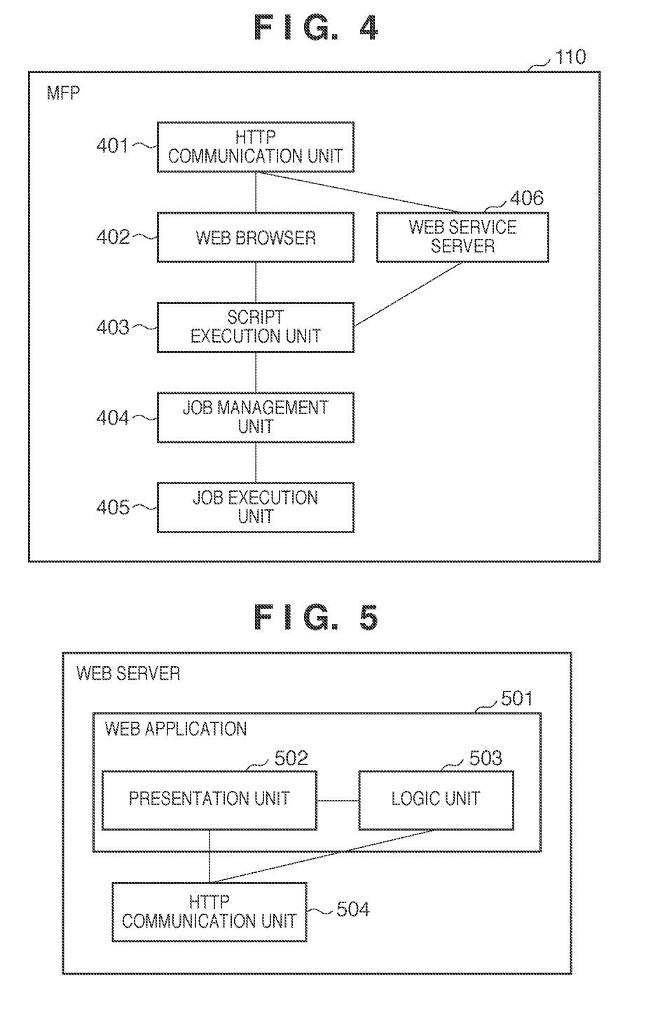

FIG. 4 is a block diagram showing the configuration of the software modules of the MFP 110 associated with communication processing in this embodiment. These software modules are stored in the HDD 204 of the MFP 110. The CPU 201 reads out the software modules from the HDD 204 into the RAM 203, and executes them, thereby implementing functions of the software modules in the MFP 110. An HTTP communication unit 401 is a software module which makes communication via the network interface 206 according to the HTTP protocol.

A Web browser 402 is a browser which functions as a display control means, and communicates with the Web server 120 via the HTTP communication unit 401. The Web browser 402 requests, of the Web server 120, HTML data (screen information) of an operation screen described in HTML. The Web browser 402 renders the HTML data of the operation screen received from the Web server 120 via the HTTP communication unit 401, and displays the operation screen on the operation unit 111. The Web browser 402 then notifies the Web server 120 of information input through the operation screen displayed on the operation unit 111.

A script execution unit 403 receives a script generated by the Web server 120 from the Web server 120 via the Web browser 402, and parses the received script. With this operation, the script execution unit 403 extracts one or more pieces of job information contained in the received script. The script execution unit 403 also instructs a job management unit 404 to execute jobs based on the extracted job information in an order specified in the received script. The script execution unit 403 causes a Web service server 406, which provides a service (Web service) in the MFP 110, to provide as a Web service a processing interface for causing the script execution unit 403 to execute processing. Examples of the processing interface (Web service) of the script execution unit 403 include an interface for acquiring information indicating an execution status of a script including a status of a job in progress, and an interface for controlling a job managed by the job management unit 404. In the case of a scan job, control of the job includes scan cancellation, and control of replacing a document to restart scanning.

The job management unit 404 manages job information in response to an instruction from the script execution unit 403, and instructs a job execution unit 405 to execute a job based on the managed job information. The job execution unit 405 is a module for executing processing (a job) based on job information in response to an instruction from the job management unit 404. If, for example, the job to be executed is a scan job, the job execution unit 405 executes a job for reading a paper document by operating the scanner unit 112, and saving image data in the HDD 204. If the job to be executed is a transmission job, the job execution unit 405 executes a job for transmitting image data stored in the HDD 204 by operating the network I/F 206. In this embodiment, the script execution unit 403, job management unit 404, and job execution unit 405 function as an execution control means.

The Web service server 406 is a software module, which functions as a service providing means, has a server function of providing a Web service. The Web service server 406 provides a Web service for controlling the script execution unit 403 when it is called by the script execution unit 403. The Web service server 406 can call the script execution unit 403 in accordance with the called Web service.

(Software Configuration of Web Server)

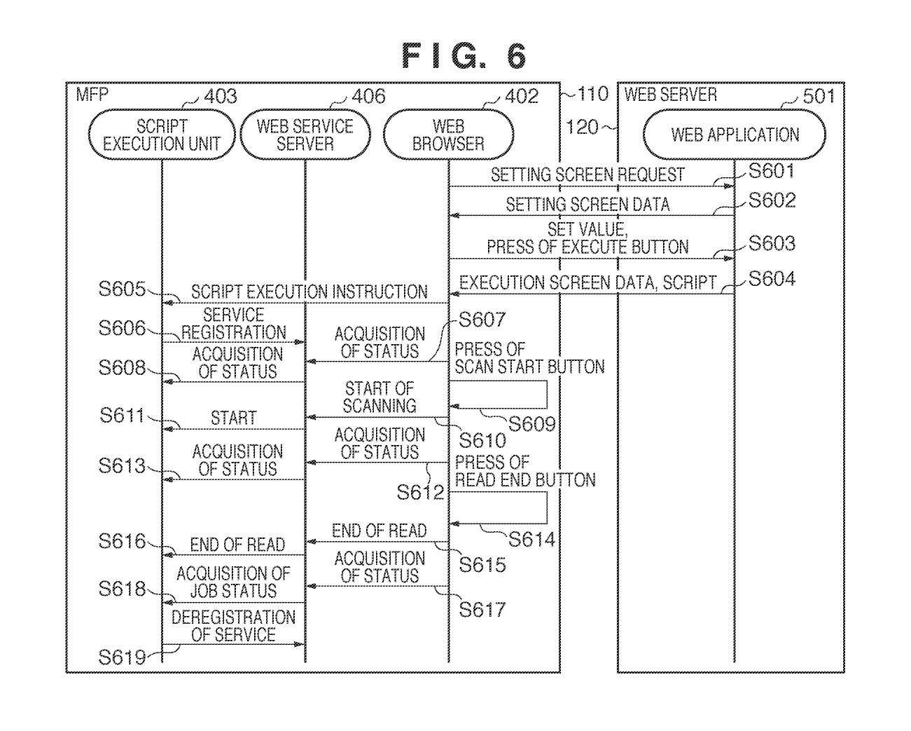

FIG. 5 is a block diagram showing the configuration of the software modules of the Web server 120 in this embodiment. The Web server 120 includes a Web application 501 and HTTP communication unit 504 as software modules. The Web application 501 includes a presentation unit 502 and logic unit 503. These software modules are stored in the HDD 306 of the Web server 120. The CPU 301 reads out the software modules from the HDD 306 into the RAM 302, and executes them, thereby implementing functions of the software modules in the Web server 120.

In response to a request from the MFP 110, the presentation unit 502 transmits, as a response, HTML data of an operation screen to be displayed on the Web browser 402 of the MFP 110 to the MFP 110 via the HTTP communication unit 504. The presentation unit 502 receives, from the MFP 110 via the HTTP communication unit 504, input information which has been input by the user through the operation screen displayed by the Web browser 402 of the MFP 110.

The logic unit 503 processes the input information from the MFP 110, which has been passed from the presentation unit 502. For example, the logic unit 503, based on the user input information, changes a screen to be displayed in the MFP 110, and generates job definition information (a script) for causing the MFP 110 to execute a function of the device of the MFP 110. The HTTP communication unit 504 serves as a software module for operating the network I/F 305 to make communication according to the HTTP protocol.

(Execution Sequence of Job)

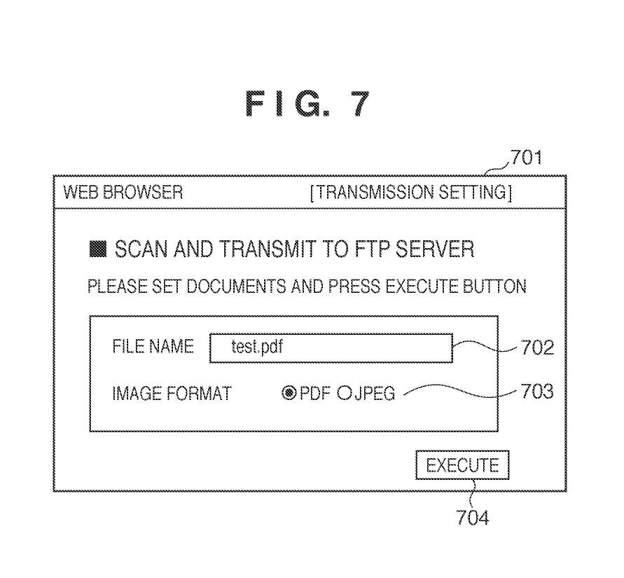

FIG. 6 is a sequence chart showing a series of processes executed in the information processing system in this embodiment. As an example of processing executed in the information processing system, “scan and transmission processing” executed according to the sequence chart shown in FIG. 6 will be described. In this embodiment, “scan and transmission processing” corresponds to processing of interactively scanning and reading a paper sheet placed on a document table to generate image data using the scanner unit 112 of the MFP 110, and transmitting the generated image data to an FTP server (not shown) on the LAN 100.

When the user presses a hardware button (not shown) for executing a transmission function, which is provided on the operation unit 111 of the MFP 110, the MFP 110 starts the Web browser 402. In order to display, on the operation unit 111, a setting screen for executing processing in the MFP 110, the Web browser 402 requests, of the Web application 501 in the Web server 120, HTML data of the setting screen. In this example, assume that the MFP 110 has been configured, in advance, to request the HTML data of the setting screen based on a URL indicating the location of the contents of the setting screen at startup.

In step S601, the Web browser 402 of the MFP 110 sends a request (setting screen request) to the Web application 501 holding the contents of the setting screen specified by the above URL using the GET command of HTTP. More specifically, when the Web browser 402 transmits the URL of the setting screen to the HTTP communication unit 401, the HTTP communication unit 401 communicates with the HTTP communication unit 504 of the Web server 120 according to the HTTP protocol. Upon receiving the URL from the HTTP communication unit 401, the HTTP communication unit 504 notifies the Web application 501 that an appropriate request has been sent. With this processing, the Web browser 402 sends the request to the Web application 501. Note that a description of an operation of the HTTP communication units 401 and 504 which is inevitably executed when the MFP 110 and the Web server 120 communicate with each other will be omitted for the sake of simplicity.

In step S602, in response to the request in step S601, the presentation unit 502 of the Web application 501 generates HTML data (setting screen data) of the setting screen, and transmits the generated HTML data to the Web browser 402 as a response to the request. The Web browser 402 parses the received HTML data, and displays the setting screen (operation screen) on the operation unit 111.

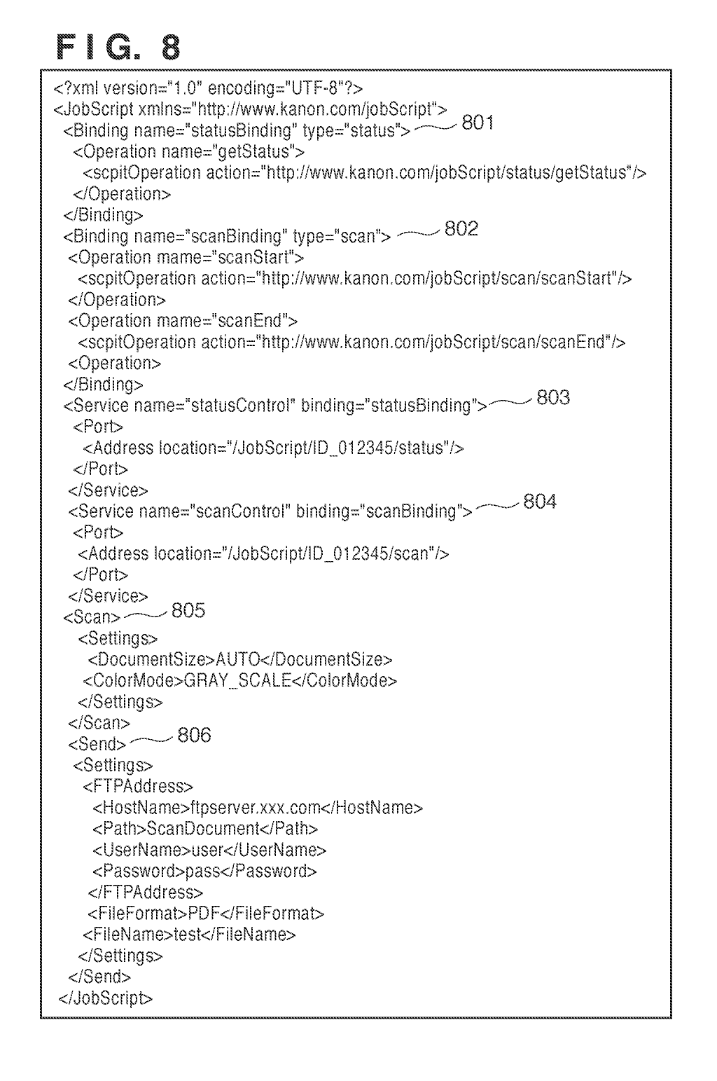

FIG. 7 shows an example of the setting screen displayed on the operation unit 111 by the Web browser 402 as a result of step S602. A setting screen (GUI panel) 701 includes a text box 702 for setting a file name, and a radio button 703 for selecting an image format. In this example, it has been set in the setting screen 701 that a file name “test.pdf” is to be given to image data, and image data is to be generated in a PDF format. A GUI button 704 is used to instruct execution of a function based on the setting contents. When the user presses the GUI button 704, execution of processing (start of scanning) is instructed.

In step S603, the Web browser 402 notifies the Web application 501 that execution of the processing has been instructed. When the user presses the GUI button 704, the Web browser 402 notifies the Web application 501 of parameters which have been set using the text box 702 and radio button 703 as setting information (set values). Assume that this communication processing uses the POST command of the HTTP protocol. With this operation, the Web browser 402 transmits, to the Web application 501, the input information which has been input through the operation screen based on the screen information provided from the Web application 501 (Web server 120).

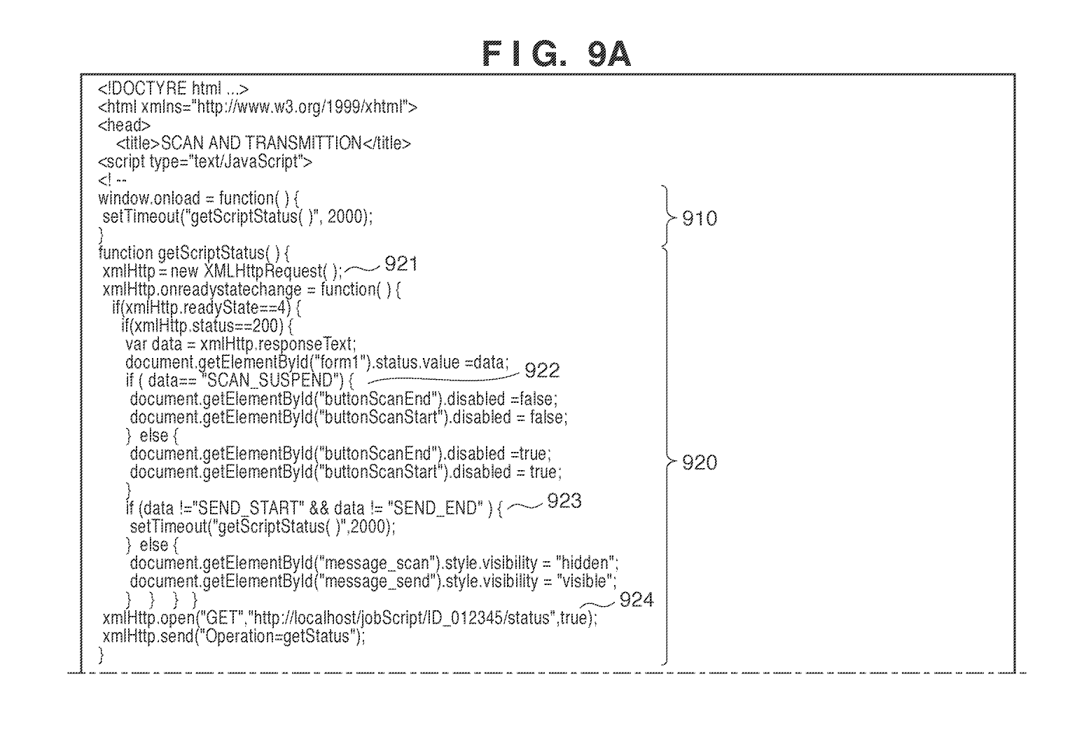

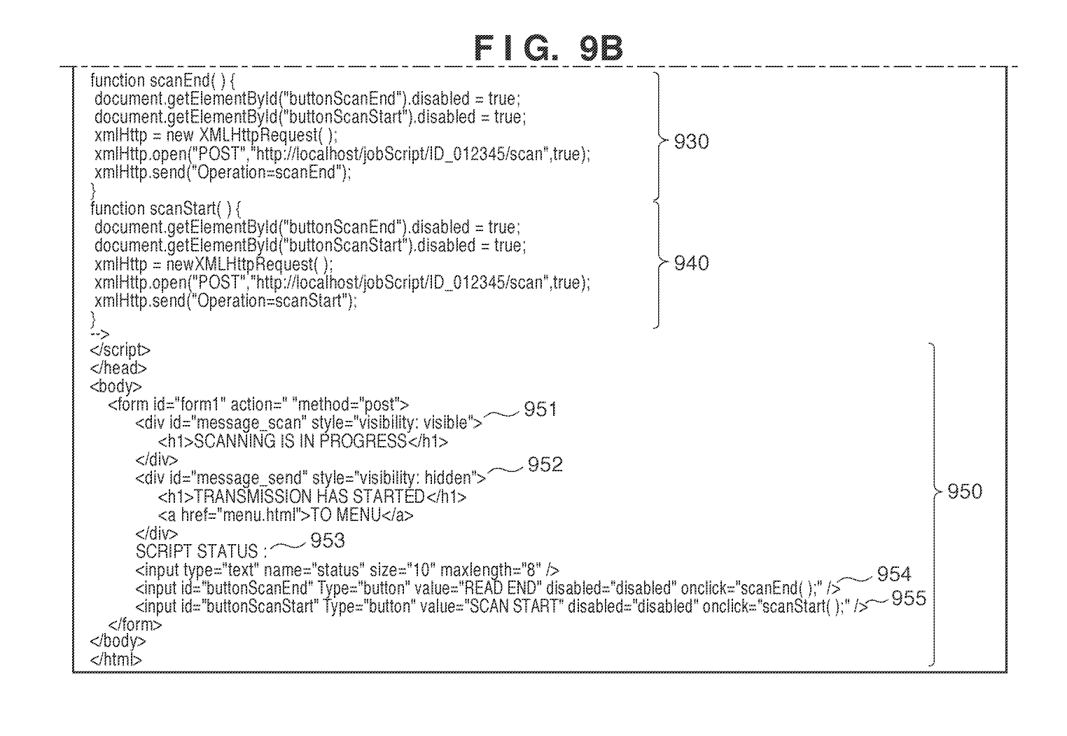

In step S604, in response to the request in step S603, the presentation unit 502 of the Web application 501 generates a processing execution request containing HTML data (execution screen data) of a screen to be displayed during execution of the processing in the MFP 110. Based on setting information contained in the POST command in step S603, the logic unit 503 generates a script for causing the MFP 110 to execute processing corresponding to the setting information. In step S604, in response to the notification in step S603, the Web application 501 transmits, as response data, the execution request containing the generated execution screen data and the script to the Web browser 402. The Web browser 402 receives the response data, and extracts the script (FIG. 8) and the HTML data (FIGS. 9A and 9B) of the execution screen from the received response data. As will be described in detail below, the script corresponds to definition information of a service (Web service) associated with the input information transmitted from the Web browser 402, and contains a URL for specifying the service. The Web browser 402 uses a Web service provided by the Web service server 406 by specifying the Web service by the URL contained in the script.

With reference to FIG. 8, the script which is received by the Web browser 402 from the Web application 501 in step S604 will be explained. The script shown in FIG. 8 is an example of a script for sequentially executing, in the MFP 110, a scan job interactively executed based on a user input and a transmission job. This script assigns an interface for acquiring a state of the script execution unit 403 and that for controlling the scan job to the Web services provided by the Web service server 406. The script shown in FIG. 8 is described in XML but may have any format as long as the MFP 110 can process the format.

A Binding tag 801 describes which processing interface of the script execution unit 403 is provided as a Web service. In this example, processing (indicated by a URI “http://www.kanon.com/jobScript/status/getStatus”) for acquiring information representing an execution status of the script of the script execution unit 403 is defined as “getStatus”. The whole processing is defined as “status Binding”.

A Binding tag 802 is similar to the tag 801. In this example, processing (indicated by a URI “http://www.kanon.com/jobScript/Scan/scanStart”) for starting scanning of the scan job is defined as “scanStart”. Processing (http://www.kanon.com/jobScript/Scan/scanEnd) for terminating scanning of the scan job is defined as “scanEnd”. A set of the two processes is defined as “scanBinding”.

A Service tag 803 defines association of the processing indicated by the tag 801 with an actual Web service. In this example, it is defined that the processing defined as “statusBinding” is assigned to a Web service with a URL represented by “/JobScript/ID_{—}012345/status/”.

A Service tag 804 defines association of the processing indicated by the tag 802 with an actual Web service. In this example, it is defined that the processing defined as “scanBinding” is assigned to a Web service with a URL represented by “/JobScript/ID_{—}012345/scan/”.

As described above, in this example, definition for associating processing interfaces of software modules within the MFP 110 with Web services is formed by a script. The definition information of the Web services is used to disclose, among the processing interfaces (Web services) provided by the script execution unit 403, processing interfaces which are needed for displaying a screen based on HTML data (to be described later).

In this example, the URLs specified by the tags 801 and 802 are different for each script, and correspond to the HTML data in FIGS. 9A and 9B (to be described later). Even when a plurality of scripts are simultaneously executed in the MFP 110, therefore, it is possible to handle processes executed by the scripts as different Web services.

A Scan tag 805 represents setting information of the scan job executed in the script processing. In this example, the tag 805 indicates that the scanner unit 112 should automatically determine (Auto) a scan document size (DocumentSize). The tag 805 also indicates that a color mode (ColorMode) is gray scale (GRAY_SCALE).

A Send tag 806 represents setting information of the transmission job executed in the script processing. In this example, the tag 806 indicates that transmission to a server “ftpserver.xxx.com” should be done according to the FTP protocol. The tag 806 also indicates that the format (FileFormat) of a file to be transmitted is PDF and a file name (FileName) is “test”.

Referring back to FIG. 6, in step S604, the logic unit 503 of the Web application 501 generates and transmits the above-described script, and then the Web browser 402 receives this script.

With reference to FIGS. 9A and 9B, the HTML data (execution screen data) received by the Web browser 402 from the Web application 501 will now be described. A JavaScript code is embedded in the HTML data shown in FIGS. 9A and 9B. In the MFP 110, the JavaScript code embedded in the HTML data calls the Web service server 406, thereby executing display update processing and interaction processing with the user by the script execution unit 403 in accordance with an execution status of the script. This shows an example of the HTML data used for displaying a screen on the operation unit 111 up to when the interaction processing associated with the scan job executed according to the script shown in FIG. 8 is performed and the transmission job is executed.

Blocks 910, 920, 930, and 940 include JavaScript codes for updating screen display on the operation unit 111 based on an execution status of the script.

The block 910 defines that a timer is set for a predetermined time period (for example, two seconds), and when a time-out occurs, a getScriptStatus function is called. When a screen based on the HTML data is displayed, the Web browser 402 executes the JavaScript code in the block 910.

The getScriptStatus function in the block 920 includes blocks 921, 922, 923, and 924. This function is described in JavaScript for performing HTTP communication with a Web service of the Web service server 406 in the background, and acquiring information indicating an execution status of the script through the communication process.

The block 921 defines that an object (XMLHttpRequest) for performing background communication is generated, and processing to be executed in communication in the blocks 922 and 923 is registered.

The block 922 is a portion called when background communication succeeds, and defines that whether a response acquired in the communication process indicates a scan standby state (a character string “SCAN_SUSPEND”) is determined. According to the block 922, if the response indicates a scan standby state, a scan end button (a button with an ID “buttonScanEnd”) and a scan start button (a button with an ID “buttonScanStart”) are enabled; otherwise, the display of these buttons is disabled.

The block 923 is a portion called when background communication succeeds, and defines that whether a response acquired in the communication process indicates a transmission state (a character string “SEND_START”) or a transmission end state (a character string “SEND_END”) is determined. In this example, these two states mean that the scan job defined in the script has been already terminated, and the process has advanced to the transmission job.

If it is determined that the scan job is still in progress, a timer is set for two seconds again. When a time-out occurs, the getScriptStatus function in the block 920 is called. If it is determined that the transmission job has started, a block 951 (a display region indicated by message_scan) is caused not to be displayed and a block 952 (a region indicated by message_send) is caused to be displayed.

In the block 924, communication is executed by specifying an URL in the object for background communication generated in the block 921. The URL is defined in the script passed from the Web server 120, as explained in FIG. 8.

As described above, the JavaScript code in the block 920 defines that the URL of the Web service enabled by the script received from the Web application 501 together with the HTML data is used to acquire the information indicating an execution status of the script execution unit 403, thereby updating the display.

A scanEnd function in the block 930 is described in JavaScript for performing HTTP communication with the Web service server 406 in the background, and instructing to terminate scanning. Similarly to the block 920, the URL of the Web service for controlling the scan job defined in the script received from the Web server 120 is accessed. Thus, this function instructs, via the Web service server 406, the script execution unit 403 to terminate scanning.

A scanStart function in the block 940 is described in JavaScript for performing HTTP communication with the Web service server 406 in the background, and instructing to start scanning. Similarly to the block 930, the URL of the Web service for controlling the scan job defined in the script received from the Web server 120 is accessed. Thus, this function instructs, via the Web service server 406, the script execution unit 403 to start scanning.

A block 950 is a portion describing screen information in HTML. The block 951 represents a description for displaying, on a screen, a message indicating that scanning is in progress. The block 952 represents a description for displaying, on a screen, a message indicating that transmission has started. As for screen display based on these descriptions, the JavaScript code in the block 923 controls display/non-display on the screen, as described above.

A block 953 represents a description for displaying an execution status of the script on the screen. A block 954 represents a description about display of a button for instructing termination of the scan job. When the button is pressed, the JavaScript code in the block 930 is called. The JavaScript code in the block 922 switches between enabling and disabling of the button.

A block 955 represents a description about display of a button for instructing start of scanning in the scan job. When the button is pressed, the JavaScript code in the block 940 is called. The JavaScript code in the block 922 switches between enabling and disabling of the button. The above-described HTML data controls the screen using the Web service defined based on the script in FIG. 8.

Referring back to FIG. 6, in step S605, among the execution screen data (screen information) and the script (Web service definition information) contained in the execution request received from the Web server 120 in step S604, the Web browser 402 transmits the script to the script execution unit 403. With this operation, the Web browser 402 sends an execution instruction of the script to the script execution unit 403. Upon receiving the script, the script execution unit 403 executes the received script, as shown in FIG. 10. In this way, the script execution unit 403 executes processing according to the execution request from the Web server 120 (Web application 501).

FIG. 10 is a flowchart illustrating a processing procedure of executing, by the script execution unit 403, the script received from the Web application 501. In step S1001, the script execution unit 403 parses the script received in step S605, and registers in the Web service server 406 URLs described in the script. The script execution unit 403, in turn, registers in the Web service server 406 Web services defined by the definition information described in the script. With this operation, the Web service server 406 provides, among a plurality of providable Web services, the Web services registered by the script execution unit 403. The Web browser 402 can use the Web services registered by the script execution unit 403 among the Web services providable by the Web service server 406.

As detailed registration processing, the script execution unit 403 configures the Web service server 406 to call the script execution unit 403 when the Web browser 402 sends a request for the registered URLs. In the example of FIG. 8, the script execution unit 403 enables two Web services via the Web service server 406. Note that step S1001 corresponds to step S606.

In step S1002, the script execution unit 403 extracts one or more pieces of job information from the script (divides the script into jobs), and registers the extracted job information in the job management unit 404. In the example of FIG. 8, the script execution unit 403 registers, as Web services, information about two jobs including a scan job and a transmission job in the job management unit 404. In step S1003, in response to a request from the script execution unit 403 via the job management unit 404, the job execution unit 405 sequentially executes the registered jobs.

Upon accepting the request for the registered Web services (from the Web browser 402), the Web service server 406 instructs the script execution unit 403 to execute processing corresponding to the request. If the script execution unit 403 receives the instruction from the Web service server 406 in step S1004, the process advances to step S1005; otherwise, the process advances to step S1006. In step S1005, the script execution unit 403 executes the processing corresponding to the request accepted by the Web service server 406 by performing the processing instructed from the Web service server 406.

In the example of FIG. 8, if a Web service for acquiring information indicating an execution status of the script is called (that is, execution of the Web service is requested), the script execution unit 403 determines the execution status of the script, and transmits, as a response, a determination result to a client (that is, the Web browser 402) as a request source via the Web service server 406. If a Web service for controlling execution of the scan job is called, the script execution unit 403 controls, via the job management unit 404, execution of the scan job by the job execution unit 405.

In step S1006, based on a monitoring result of the job execution unit 405 by the job management unit 404, the script execution unit 403 determines whether execution of the job is complete. If the job is complete, the process advances to step S1007; otherwise, the process advances to step S1004. In step S1007, based on the monitoring result of the job execution unit 405 by the job management unit 404, the script execution unit 403 determines whether all the jobs described in the script are complete. If not all of the jobs are complete, the process advances to step S1003 to execute the next job; otherwise, the process advances to step S1008.

In step S1008, upon accepting a request for the registered Web services, the Web service server 406 instructs the script execution unit 403 to execute processing corresponding to the request, as in step S1004. If the Web service server 406 accepts a request for the Web services, the process advances to step S1009; otherwise, the process advances to step S1010. In step S1009, the script execution unit 403 executes the processing corresponding to the request accepted by the Web service server 406 by performing the processing instructed from the Web service server 406, as in step S1005.

In step S1010, the script execution unit 403 determines whether to disable the Web services. If the unit 403 determines to disable the Web services, the process advances to step S1011; otherwise, the process advances to step S1008. In this embodiment, as an example, when a predetermined time period elapses after execution of the jobs ends, the script execution unit 403 determines to disable the Web services. This time period may be set in the script execution unit 403 in advance, or may be described within the script received from the Web server 120. That is, the Web service server 406 provides the Web services until the Web server 120 instructs, using the script, to disable the services or until a predetermined time period elapses after execution of the processing (jobs) by the script execution unit 403 ends.

If the script execution unit 403 determines in step S1010 to disable the Web services, it causes the Web service server 406 to delete the URLs registered in the Web service server 406 in step S1001, thereby disabling the Web services corresponding to the URLs in step S1011.

Referring back to FIG. 6, according to the processing sequence shown in FIG. 10, display control based on the HTML data (FIGS. 9A and 9B) by the Web browser 402 will be described. In step S605 described above, the Web browser 402 transmits the script to the script execution unit 403 to instruct execution of the script, and parses the HTML data (execution screen data) received from the Web application 501 together with the script to display a screen based on the HTML data on the operation unit 111.

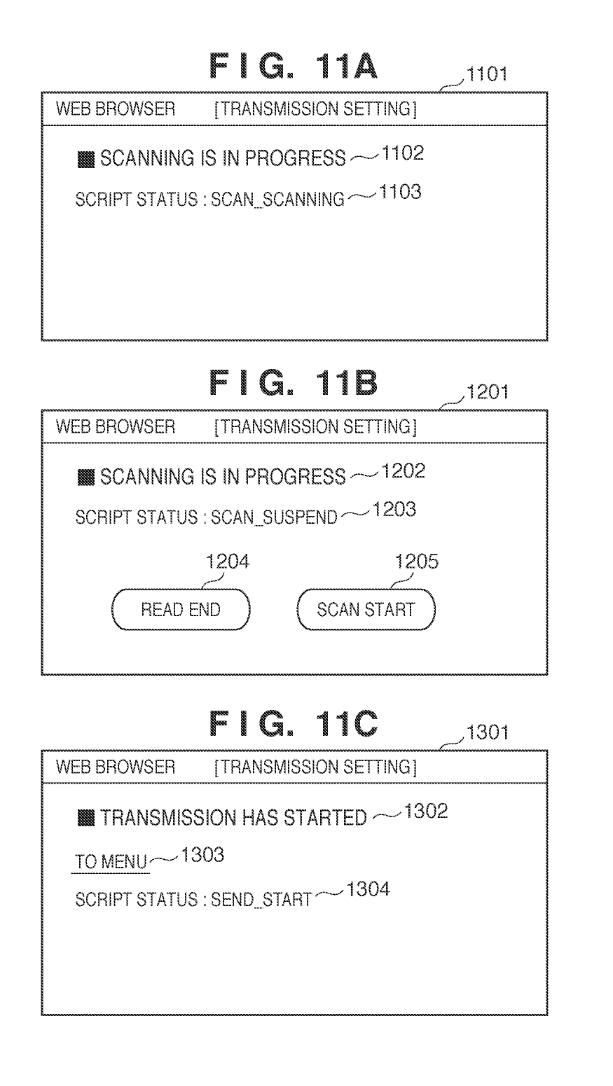

FIG. 11A shows an example of the screen displayed on the operation unit 111 by the Web browser 402. As shown in FIG. 11A, the Web browser 402 displays information 1102 based on the block 951 of FIG. 9B and information 1103 based on the block 953 of FIG. 9B within a display region 1101. The information 1103 represents, as initial display about an execution status of the script, “SCAN_SCANNING” indicating that scanning processing is in progress.

Step S606 corresponds to step S1001 in FIG. 10, in which the script execution unit 403 registers in the Web service server 406 the Web services based on the script received in step S605. In this example, the unit 403 registers in the Web service server 406 two Web services including a Web service for acquiring information indicating an execution status of the script in the Web service server 406, and that for controlling execution of the scan job. This registration processing is implemented by registering, in the Web service server 406, URLs corresponding to the Web services described in the script. This allows the Web browser 402 to use the Web services by specifying the registered URLs.

In step S607, the Web browser 402 uses the JavaScript code in the block 920 contained in the HTML data (FIGS. 9A and 9B) to call the Web service for acquiring information indicating an execution status of the script among the Web services enabled in step S606.

Step S608 corresponds to step S1004 in FIG. 10, in which the Web service server 406 calls the script execution unit 403 to execute processing corresponding to the Web service requested from the Web browser 402. In response to this, the script execution unit 403 transmits an execution status of the script to the Web browser 402 via the Web service server 406. In this example, assume that the scan job is in a standby state at this time, and the unit 403 transmits a character string “SCAN_SUSPEND” indicating a state of the scan job to the Web browser 402. The Web browser 402 changes the display according to the JavaScript code in the block 922. As described above, the Web browser 402 acquires information indicating an execution status of the script based on the timer of the JavaScript code via the Web service server 406, and changes the screen display based on the acquired information.

FIG. 11B shows an example of a screen displayed on the operation unit 111 by the Web browser 402 as a result of step S608. As shown in FIG. 11B, the Web browser 402 displays information 1202 based on the block 951 of FIG. 9B and information 1203 based on the block 953 of FIG. 9B within a display region 1201. The Web browser 402 processes the JavaScript code in the block 922 to display GUI buttons 1204 and 1205 based on the blocks 954 and 955 of FIG. 9B, respectively.

If the user presses the GUI button 1205 of FIG. 11B in step S609, processing described in the script as processing executed upon press of the GUI button 1205 is performed. More specifically, as described in FIGS. 9A and 9B, when the user presses the GUI button 1205, the Web browser 402 executes the JavaScript code in the block 940.

Upon executing the JavaScript code in the block 940, in step S610, the Web browser 402 calls the Web service for controlling execution of the scan job, which has been registered in step S605.

When the Web service is called in step S610, the Web service server 406 calls the script execution unit 403 in step S611. As explained in steps S1004 and S1005 of FIG. 10, the script execution unit 403 controls, via the job management unit 404, the job execution unit 405 to start scanning of the scan job. As described above, the Web service used in steps S610 and S611 corresponds to a service for controlling job execution by the script execution unit 403 based on information input through the operation screen displayed by the Web browser 402 during execution of the scan job.

As in steps S607 and S608, in steps S612 and S613, the JavaScript code in the block 920 called based on the timer calls the Web service for acquiring an execution status of the script, and causes the script execution unit 403 to execute processing corresponding to the Web service.

Assume that the scan processing is in a standby state again and the screen shown in FIG. 11B is displayed. At this time, in step S614, when the user presses the GUI button 1204 shown in FIG. 11B, processing described in the script as processing executed upon press of the GUI button 1204 is performed. More particularly, as described in FIGS. 9A and 9B, when the user presses the GUI button 1205, the Web browser 402 executes the JavaScript code in the block 930.

In steps S615 and S616, the Web browser 402 and the Web service server 406 execute processing, similarly to steps S610 and S611. Then, the script execution unit 403 controls, via the job management unit 404, the job execution unit 405 to terminate the scan job. As described above, the Web service used in steps S615 and S616 corresponds to a service for controlling job execution by the script execution unit 403 based on information input through the operation screen displayed by the Web browser 402 during the scan job.

In steps S617 and S618, the JavaScript code in the block 920 called based on the timer calls the Web service server 406 for acquiring information indicating an execution status of the script, similarly to steps S607 and S608. At this time, the scan job is complete and the transmission job is in progress. The Web browser 402, therefore, receives a character string “SEND_START” from the Web service. The Web browser 402 uses the JavaScript code in the block 923 to set non-display of information based on the block 951 and display of information based on the block 952.

FIG. 11C shows an example of a screen displayed by the Web browser 402 as a result of steps S617 and S618. As shown in FIG. 11C, the Web browser 402 displays the block 952 shown in FIG. 9B as display 1302 and a link 1303, and information 1304 based on the block 953 shown in FIG. 9B within a display region 1301. In this example, the user ends the interaction processing associated with the scan job at this time. If the user selects the link 1303, the Web browser 402 returns the display of the operation unit 111 to an initial screen.

Finally, as in steps S1010 and S1011 of FIG. 10, the script execution unit 403 executes processing for disabling the Web services in the Web service server 406 in step S619. As described above, when a predetermined time period elapses after execution of the script (jobs) ends, the unit 403 executes the processing.

As explained above, in this embodiment, the Web browser 402 can control screen display and function execution in the MFP 110 by instructions from the Web application 501 (Web server 120). More specifically, the Web browser 402 displays an operation screen based on screen information provided by the Web server 120, and transmits input information input through the operation screen to the Web server 120. The Web browser 402 receives from the Web server 120 an execution request of processing corresponding to the input information, and passes a script contained in the received execution request to the script execution unit 403. The script contains definition information of a Web service for controlling the script execution unit 403. The script execution unit 403 registers in the Web service server 406 the Web service defined in the definition information contained in the script. The Web service server 406 provides the Web browser 402 with the registered Web service of Web services providable during execution of the processing by the script execution unit 403.

In this way, when executing a function of the MFP 110 according to a request from the Web server 120 in the MFP 110, it is possible to enable a service for controlling the execution processing as needed. Consequently, as compared with a case in which all the providable services are always available in the MFP 110, it is possible to avoid wasting the resources of the MFP 110 such as a memory.

In addition to the above-described script, the execution request from the Web server 120 contains screen information about an operation screen to be displayed by the Web browser 402 while the script execution unit 403 executes the processing according to the execution request. The Web browser 402 uses a service provided by the Web service server 406 to control display based on the screen information received from the Web server 120. According to this embodiment, in display control by the Web browser 402 during execution of the processing by the script execution unit 403, a service provided by the Web service server 406 is enabled as needed, thereby avoiding wasting the resources of the MFP 110, as described above.

It is possible to change a URL for specifying a Web service by an instruction from the Web server 120. As compared with a case in which the MFP 110 has a fixed Web service, therefore, it is possible to form a function necessary for display control as a necessary Web service, thereby allowing more flexible control in the MFP 110.

### Second Embodiment

In the first embodiment, the MFP 110 executes processing based on the HTML data and script received from the Web application 501. In the second embodiment, a case in which display control of an MFP 110 is done when a Web application 501 transmits appropriate HTML data to the MFP 110 in accordance with an execution status of a script will be explained. In the second embodiment, for the sake of simplicity, a description of the same parts as in the first embodiment will be omitted, and different parts will be mainly explained. More specifically, the second embodiment is different from the first embodiment in respective processing sequences executed by software modules in the MFP 110 and those in a Web server 120.

(Execution Sequence of Job)

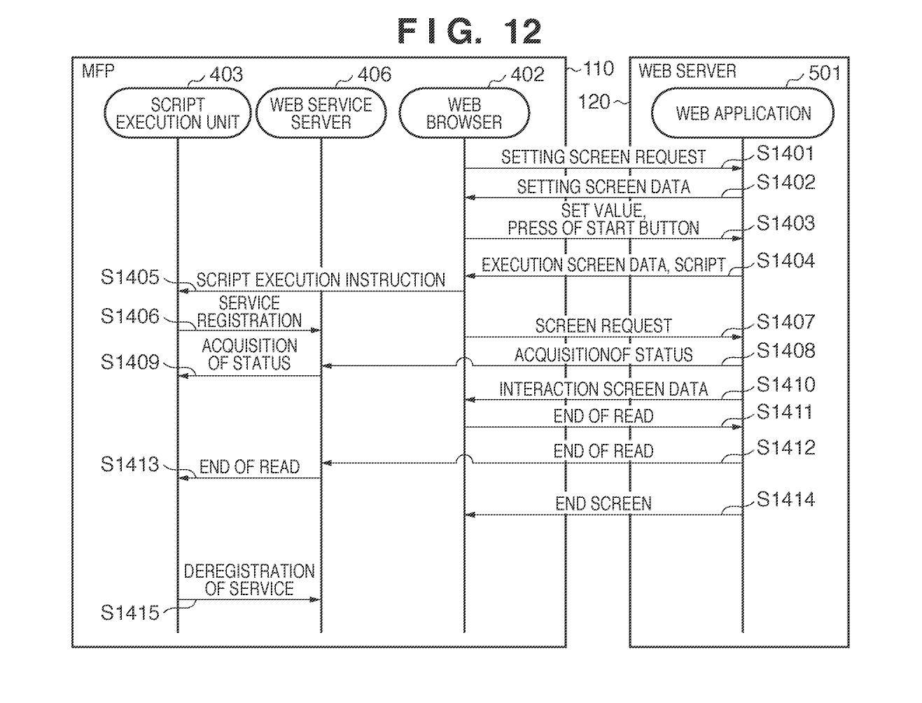

FIG. 12 is a sequence chart showing a series of processes executed in the information processing system in the second embodiment. With reference to FIG. 12, as in FIG. 6, a case in which scan and transmission processing is executed in the MFP 110 will be explained. After start of a Web browser 402, processing from step S1401 to step S1406 is the same as that from step S601 to step S606 in the first embodiment. In the second embodiment, however, in step S1404, the Web browser 402 receives, from the Web application 501, HTML data different from that (FIGS. 9A and 9B) in the first embodiment.

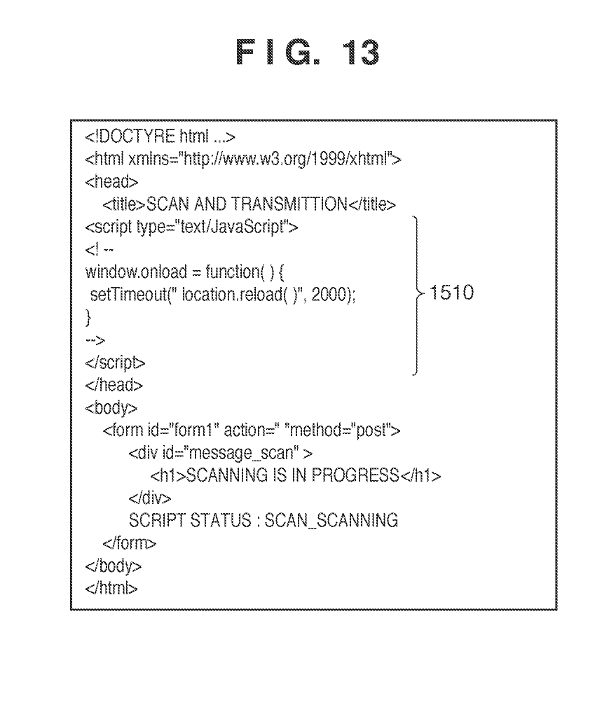

FIG. 13 shows an example of the HTML data transmitted from the Web application 501 to the Web browser 402 in step S1404. As shown in FIG. 13, unlike the first embodiment, the HTML data does not describe the JavaScript code for calling a Web service by the Web browser 402. Instead, in the second embodiment, based on a JavaScript code in a block 1510, the Web browser 402 sends a request to the Web application 501 when a predetermined time period elapses. In step S1404, the Web application 501 transmits, to the Web browser 402, response data containing the HTML data shown in FIG. 13 and the script explained in the first embodiment.

In step S1407, the Web browser 402 sends a request (screen request) of screen information to the Web application 501 based on the HTML data (FIG. 13). In steps S1408 and S1409, the Web application 501 communicates with a Web service server 406 in response to the screen request in step S1407, and calls a Web service for acquiring an execution status of the script. At this time, the Web application 501 specifies a URL for the Web service contained in the script transmitted in step S1404. In this example, as a result of step S1408, the Web application 501 receives a character string indicating that a scan job is in a standby state.

In step S1410, the Web application 501 acquires information indicating that the scan job is in a standby state as a result of step S1408. As in FIG. 11B, therefore, the Web application 501 transmits the HTML data for interaction processing with the user to the Web browser 402. In the first embodiment, when the user presses the GUI button 1204 or 1205, the Web browser 402 uses the JavaScript code to call the Web service. On the contrary, in this embodiment, the Web application 501 notifies the Web service server 406 of it.

In step S1411, the user instructs to terminate the scan job through the same screen as in FIG. 11B. Upon receiving a notification indicating end of scanning from the Web browser 402 in step S1411, the Web application 501 communicates with the Web service server 406 to call the Web service for controlling the scan job in step S1412. At this time, the Web application 501 transmits a request to the URL specified in step S1404 to call the Web service.

In step S1413, the Web service server 406 calls a script execution unit 403 as in step S1409. Consequently, the script execution unit 403 controls the scan job as in the first embodiment. After that, in step S1414, the Web application 501 transmits, to the Web browser 402, the HTML data for displaying the same screen as in FIG. 11C as a response to the request from the Web browser 402 in step S1411.

In step S1415, the script execution unit 403 disables the Web service of the Web service server 406, similarly to the first embodiment.

As described above, in the second embodiment, while the script execution unit 403 executes processing according to a processing execution request from the Web application 501 (Web server 120), the Web browser 402 requests screen information of the Web server 120. Upon receiving the request, the Web server 120 uses the provided Web service which has been registered in the Web service server 406 of the MFP 110 to generate screen information to be displayed by the Web browser 402, and transmits the generated information to the Web browser 402. The Web browser 402 displays an operation screen based on the received screen information. According to the second embodiment, the Web server 120 can use, as needed, the Web service registered in the Web service server 406 to perform display control of the MFP 110 even if the Web server 120 has a leading role in performing the display control processing instead of the Web browser 402 while the script execution unit 403 executes the processing.

### Other Embodiments

In the above-described first and second embodiments, a Web service of the Web service server 406 is set to be disabled when a predetermined time period elapses after the script is executed. The present invention, however, is not limited to this. For example, a Web service server 406 may provide a Web service for disabling a Web service, or an instruction for disabling a Web service may be accepted according to any protocol. These conditions may be described in a script received from a Web application 501. In this way, it is possible to flexibly perform control for disabling a Web service of an MFP 110 from the Web application 501.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2010-130448, filed Jun. 7, 2010 and 2011-112898, filed May 19, 2011, which are hereby incorporated by reference herein in their entirety.

1. An information processing apparatus connectable to a Web server, the information processing apparatus comprising:
a display controller including:
a transmitter for displaying an operation screen based on screen information provided by the Web server, and transmitting input information input through the operation screen to the Web server, and
a receiver for receiving, from the Web server, an execution request of processing corresponding to the input information transmitted by the transmitter the execution request containing definition information of a service associated with execution of the processing;
an execution controller for executing, upon receiving the execution request from the Web server via the display controller processing according to the execution request; and
a service provider for providing, among a plurality of providable services for controlling the execution controller a service that is registered by the execution controller
wherein the execution controller includes a registration unit for registering in the service provider the service defined in the definition information contained in the execution request when starting execution of the processing according to the execution request.

2. The apparatus according to claim 1, wherein the service provider provides the service registered by the execution controller until the Web server instructs to disable the service or until a predetermined time period elapses after the processing according to the execution request by the execution controller ends.

3. The apparatus according to claim 1 wherein
the execution request further includes screen information about an operation screen to be displayed during execution of the processing according to the execution request by the execution controller and
the display controller uses the service provided by the service provider to control display based on the screen information received from the Web server.

4. The apparatus according to claim 3, wherein
the execution request contains definition information of a service for acquiring, from the execution controller information indicating an execution status of the processing by the execution controller and
the display controller acquires the information indicating the execution status of the processing according to the execution request from the execution controller via the service provided by the service provider and updates the display based on the screen information in accordance with the acquired information.

5. The apparatus according to claim 3 wherein
the execution request contains definition information of a service for controlling execution of the processing by the execution controller based on information input through the operation screen displayed by the display controller during execution of the processing by the execution controller and
the display controller further includes a unit for instructing, via the service provided by the service provider the execution controller to control execution of the processing based on the information input through the operation screen being displayed.

6. The apparatus according to claim 3, wherein
the display controller further includes a request unit for requesting the screen information of the Web server during execution of the processing according to the execution request by the execution controller,
upon receiving the request from the request unit, the Web server generates screen information to be displayed by the display controller using the service provided by the service provider, and transmits the generated screen information to the display controller, and
the display controller displays an operation screen based on the screen information received from the Web server.

7. The apparatus according to claim 3, wherein
the execution request includes a script including, as definition information of a service, a URL for specifying the service,
the service provider provides, as a service to be registered by the execution controller, a Web service specified by the URL, and
the display controller serves as a Web browser that uses a Web service provided by the service provider by specifying the Web service by the URL contained in the script corresponding to the execution request.

8. The apparatus according to claim 1, wherein the processing according to the execution request is executed based on a scan job for reading an image on a document and generating image data.

9. A control method for controlling an information processing apparatus connectable to a Web server, the control method comprising:
causing a display control unit of the information processing apparatus to display an operation screen based on screen information provided by the Web server, and transmit input information input through the operation screen to the Web server;
causing the display control unit to receive, from the Web server, an execution request of processing corresponding to the input information transmitted in the causing of the display control unit to display, the execution request containing definition information of a service associated with execution of the processing;
causing an execution control unit of the information processing apparatus to execute, upon receiving the execution request from the Web server via the display control unit, processing according to the execution request; and
causing a service providing unit of the information processing apparatus to provide, among a plurality of providable services for controlling the execution control unit, a service that is registered by the execution control unit,
wherein the causing of the execution control unit to execute includes registering in the service providing unit the service defined in the definition information included in the execution request when starting execution of the processing according to the execution request.

10. A non-transitory computer-readable storage medium storing a program for causing a computer to execute a control method for an information processing apparatus, the control method comprising:
causing a display control unit of the information processing apparatus to display an operation screen based on screen information provided by the Web server, and transmit input information input through the operation screen to the Web server;
causing the display control unit to receive, from the Web server, an execution request of processing corresponding to the input information transmitted in the causing of the display control unit to display, the execution request containing definition information of a service associated with execution of the processing;
causing an execution control unit of the information processing apparatus to execute, upon receiving the execution request from the Web server via the display control unit, processing according to the execution request; and
causing a service providing unit of the information processing apparatus to provide, among a plurality of providable services for controlling the execution control unit, a service that is registered by the execution control unit,
wherein the causing of the execution control unit to execute includes registering in the service providing unit the service defined in the definition information included in the execution request when starting execution of the processing according to the execution request.
